(19) United States
(12) Patent Application Publication
(10) Pub. No.: US 2013/0296432 A1
(43) Pub. Date: Nov. 7, 2013

(54) BENZOIC ACID-ENRICHED PLANT EXTRACTS AND USE THEREOF

(71) Applicant: EPC (BEIJING) NATURAL PRODUCTS CO., LTD., Beijing (CN)

(72) Inventors: Jingang Shi, Beijing (CN); Wenchao Lu, Beijing (CN); Feng Sun, Beijing (CN)

(73) Assignee: EPC (Beijing) Natural Products Co., Ltd., Beijing (CN)

(21) Appl. No.: 13/799,512

(22) Filed: Mar. 13, 2013

Related U.S. Application Data
(60) Provisional application No. 61/642,592, filed on May 4, 2012.
(60) Provisional application No. 61/776,979, filed on Mar. 12, 2013.

(51) Int. Cl. A01N 37/10; A23B 7/10

(52) U.S. Cl. CPC A01N 37/10; A23B 7/10
USPC 514/568; 562/493; 426/650

(57) ABSTRACT

Disclosed herein are benzoic acid-enriched plant extracts and uses thereof Specifically, benzoic acid-enriched plant extracts free of toxic substances and organic solvents and use thereof are disclosed. More specifically, a benzoic acid-enriched lingonberry extract free of toxic substances and organic solvents and its use as a preservative is provided.

### CROSS REFERENCE TO RELATED APPLICATIONS

This application claims priority to U.S. Provisional Patent Application No. 61/642,592, filed May 4, 2012, and U.S. Provisional Patent Application No. 61/776,979, filed Mar. 12, 2013, both entitled “BENZOIC ACID-ENRICHED PLANT EXTRACTS AND USE THEREOF” which are incorporated by reference in their entirety.

### FIELD OF THE INVENTION

Benzoic acid-enriched plant extracts and uses thereof are generally described. Specifically, benzoic acid-enriched plant extracts free of toxic substances and/or organic solvents and uses thereof are disclosed. More specifically, a benzoic acid-enriched lingonberry extract free of toxic substances and/or organic solvents and, in one aspect, its use as a preservative are detailed.

### BACKGROUND OF THE INVENTION

Benzoic acid is widely used in the food industry as a preservative in acidic foods, owing to its antimicrobial activity against various bacteria, yeasts and fungi involved in food poisoning and food spoilage, such as Escherichia coli, Listeria monocytogenes, and Aspergillus sp. (R. Sieber, U. Biitikofer & J. O. Bosset, Benzoic Acid as a Natural Compound in Cultured Dairy Products and Cheese, Int. Dairy Journal 5 (1995) 227-246). Typical levels of benzoic acid as a preservative in food is 0.05-0.1%.

Benzoic acid was first prepared by dry distillation of gum benzoin in the sixteenth century. Currently, benzoic acid is produced commercially by partial oxidation of toluene with oxygen. Although benzoic acid can be synthesized with low cost and high yield on an industrial scale, benzoic acid thus obtained inevitably contains many unwanted chemical substances, e.g. toxic substances and/or organic solvents, which might not be approved in certain circumstances, such as in the production of food products, especially “green foods”.

Benzoic acid occurs naturally as the free acid and bound as benzoic acid esters in many plant and animal species. Appreciable amounts have been found in many berries. Sanna Viljakainen et al. (Sanna Viljakainen, Arto Visti, and Simo Laakso, Concentrations of Organic Acids and Soluble Sugars in Juices from Nordic Berries, Acta Agric. Scand., Sect. B, Soil and Plant Sci. 52: 101-109, 2002) disclosed that lingonberry (Vaccinium vitisidaea L.), cranberry (Vaccinium oxycoccus L.), cloudberry (Rubus chamaemorus L.) and black crowberry (Empetrum nigrum) contain as much as 0.06-0.72 g/L benzoic acid, wherein lingonberry has the highest benzoic acid content of 0.72 g/L.

Lingonberry is a commercially important wild, uncultivated berry in the northern regions of the world. Although lingonberry extract might have a higher benzoic acid content, e.g. between 0.6 and 1.3 g/l in the case of lingonberry juice, than original fruit, benzoic acid is generally deemed as an undesired substance in the extract and thus is removed by various processes (Arto Visti, Sanna Viljakainen, Simo Laakso, Preparation of fermentable lingonberry juice through removal of benzoic acid by Saccharomyces cerevisiae yeast, Food Research International 36 (2003) 597-602).

Therefore, a need exists for a benzoic acid product derived from natural sources, which is free of toxic substances and/or organic solvents, and thus is useful and approvable, e.g. as a preservative, in the production of food products, especially “green foods”.

### BRIEF SUMMARY OF THE INVENTION

In one aspect, a benzoic acid-enriched plant extract, which has an increased benzoic acid content in comparison with the benzoic acid content that occurs naturally in the native plant is provided. Suitable sources for plant material include, for example, lingonberry, cranberry, cloudberry and/or black crowberry. The materials provided herein are suitable as preservatives for various food products. One advantage of the materials provided herein is that the processes to arrive at the materials do not require the use of toxic substances and/or organic solvent(s) during preparation.

### DESCRIPTION OF THE INVENTION

In one aspect, a benzoic acid-enriched plant extract is provided. As used herein, the term “plant extract” means an extract, juice, or concentrate from any part of a plant, such as the seed, leaf, fruit, flower, stem, root, tuber, bark, etc., having an appreciable amount, e.g. higher than 10 ppm, of benzoic acid.

In one aspect, the plant part is the berry. In another aspect, the plant is selected from lingonberry (Vaccinium vitisidaea L.), cranberry (Vaccinium oxycoccus L.), cloudberry (Rubus chamaemorus L.) and black crowberry (Empetrum nigrum). In still another aspect, the plant extract is an extract from lingonberry.

As used herein, the term “benzoic acid-enriched” plant extract means a plant extract that has an increased benzoic acid content, e.g. 2 to 1000 times, such as about 2, about 5, about 10, about 15, about 20, about 25, about 30, about 50, or about 1000 times higher benzoic acid content, in comparison to (relative to) the amount that occurs naturally in the native plant.

In an embodiment, the benzoic acid-enriched plant extract has an increased benzoic acid content higher than that occurs in the native plant. In one embodiment, the benzoic acid-enriched plant extract has a benzoic acid content of ≧0.05 wt. %, particularly ≧0.15 wt. %, more particularly ≧0.5 wt. %, such as 0.5-3.0 wt. %, 0.5-2.0 wt. %, 0.6-1.5 wt. %, 0.6-0.9 wt. %, about 0.5 wt. %, about 0.6 wt. %, about 0.7 wt. %, about 0.8 wt. %, about 0.9 wt. %, about 1.0 wt. %, about 1.5 wt. %, about 3.0 wt. % of the weight of the extract etc.

In another embodiment, the benzoic acid-enriched plant extract has a benzoic acid content of ≧20 wt. % of the weight of the extract, particularly ≧50 wt. % of the weight of the extract, more particularly ≧75 wt. % of the weight of the extract and even more particularly ≧90 wt. % of the weight of the extract, e.g., 93 wt. %, 94 wt. %, 95 wt. %, 96 wt. %, 97 wt. %, 98 wt. %, 99 wt. % and up to 100% conversion where only benzoic acid or a benzoic acid salt is isolated from the plant extract.

It should be understood that the processes described herein can produce benzoic acid as the major component of the extract such that a benzoic acid-enriched extract is provided that comprises substantially 100% benzoic acid. That is, benzoic acid can be isolated or purified from the fruit juices or extracts described herein.

In another embodiment, the benzoic acid-enriched plant extract has an increased benzoic acid content of from about 50 wt. % to about 99 wt. % or higher, in particular from about 60 wt. % to about 95% wt. %, more particularly from about 75 wt. % to about 90 wt. %. In one aspect, the processes described herein provide a benzoic acid-enriched extract comprising substantially 100% benzoic acid.

As discussed above, purified benzoic acid can be obtained from the processes described herein. At that point, there is only residual plant extract as a possible contaminant providing a benzoic acid-enriched extract that comprises substantially 100% by weight of benzoic acid. In one aspect, no residual plant extract remains and benzoic acid would be the sole product.

It should be understood that the term “benzoic acid” is meant to include both the free carboxylic acid where the carboxyl group is protonated under neutral or acidic conditions as well as where the carboxyl group can be in salt form when treated under basic conditions.

In an aspect, the benzoic acid-enriched plant extract does not contain any appreciable (detectable) amounts of toxic substances and/or organic solvent(s), and thus is useful and approvable, e.g. as a preservative, in the production of food products, especially “green foods”.

In another aspect, a method for preparing the benzoic acid-enriched plant extract is provided.

In one aspect, a benzoic acid-enriched plant extract can be prepared by a method comprising the steps of: 1) mixing the plant material with water, optionally with stirring, wherein the weight ratio of plant material to water is in the range of from about 0.5 to about 5, particularly from about 1 to about 3, more particularly from about 1.5 to about 2, such as 0.5, 1.0, 1.5, 2.0, 2.5, etc. to form a mixture; 2) heating the mixture, e.g., to reflux for about 1 hour or less to about 10 hours or longer and then cooling the mixture to room temperature; 3) filtering the mixture and washing the resultant filter cake with water; 4) centrifuging the filtrate e.g., at about 3000 to about 5000 rpm for a sufficient period of time, e.g., about 1 minute to about 20 minutes and concentrating the supernatant, e.g., at a temperature of about 50° C. to about 80° C., particularly about 60° C. to about 70° C., such as 50° C., 60° C., 70° C., 80° C., etc., under reduced pressure to obtain the benzoic acid-enriched extract.

In another embodiment, the benzoic acid-enriched plant extract is prepared by a method comprising the steps of: 1) mixing lingonberry with water, optionally with stirring, wherein the weight ratio of lingonberry to water is in the range of about 0.5 to about 5, particularly from about 1 to about 3, more particularly from about 1.5 to about 2, such as 0.5, 1.0, 1.5, 2.0, 2.5, etc. to afford a mixture; 2) heating the mixture to reflux for about 1 hour to about 10 hours, and then cooling the mixture to room temperature; 3) filtering the mixture and washing the resultant filter cake with water; 4) centrifuging the filtrate at about 3000 to about 5000 rpm for about 1 minute to about 20 minutes, and concentrating the supernatant at a temperature of from about 50° C. to about 80° C., particularly from about 60° C. to about 70° C., such as 50° C., 60° C., 70° C., 80° C., etc., under reduced pressure to obtain the benzoic acid-enriched extract.

In another aspect, the benzoic acid-enriched plant extract is prepared by a method comprising the steps of: 1) squeezing plant material to obtain a juice; 2) mixing the residue with water, wherein the weight ratio of plant material to water is in the range of from about 0.5 to about 5, particularly from about 1 to about 3, more particularly from about 1.5 to about 2, such as 0.5, 1.0, 1.5, 2.0, 2.5, etc., and mixing at room temperature for about 1 hour or less to about 10 hours or longer; 3) filtering the mixture and washing the resultant filter cake with water; 4) mixing the juice with the filtrate, and centrifuging the mixture, e.g., at about 3000 to about 5000 rpm for a sufficient period of time, e.g., about 1 minute to about 20 minutes, and concentrating the supernatant, for example, at a temperature of from about 40° C. to about 70° C., particularly from about 50° C. to about 60° C., such as 40° C., 50° C., 60° C., 70° C., etc., under reduced pressure to obtain the concentrate; 5) heating the concentrate, e.g, at reflux, for about 1 hour to about 5 hours; and 6) concentrating at a temperature of from about 50° C. to about 80° C., particularly from about 60° C. to about 70° C., such as 50° C., 60° C., 70° C., 80° C., etc., under reduced pressure to obtain the benzoic acid-enriched extract.

In another aspect, the benzoic acid-enriched plant extract is prepared by a method comprising the steps of: 1) squeezing plant material, such as lingnonberry to obtain a juice; 2) optionally mixing the residue with water, wherein the weight ratio of plant material to water is in the range of from about 0.5 to about 5, particularly from about 1 to about 3, more particularly from about 1.5 to about 2, such as 0.5, 1.0, 1.5, 2.0, 2.5, etc., and mixing at room temperature for about 1 hour or less to about 10 hours or longer; 3) filtering the mixture and optionally washing the resultant filter cake with water; 4) mixing the juice with the filtrate to provide a liquid, 5) heating the liquid in a range of from about 30° C. to reflux for a period of about 0.5 hours to about 2 hours, in particular about 2 hours; 6) cooling the liquid, in particular to room temperature; 7) centrifuging the mixture, e.g., at about 3000 to about 5000 rpm for a sufficient period of time, e.g., about 1 minute to about 20 minutes, and concentrating the supernatant; 8) removing the solids from the supernatant and treating the supernatant with and adsorbent, such as activated carbon, macroporous resins, an ion exchange resin, silica gel, alumina, molecular sieved, white clay, diatomite, zeolite, or mixtures thereof, etc. to form a mixture with a ratio of approximately 140:1 (volume supernatant to adsorbent); 9) stirring the mixture for a period of time from about 0.5 to about 10 hours, more particularly from about 1 to about 2 hours; 10) filtering the mixture, collecting the filtrate and treating the adsorbent with a green solvent, such as ethanol, levulinic acid, ionic liquids, supercritical fluids (e.g. supercritical carbon dioxide, for example at a ratio of about 40:1 solvent to mixture by weight; 11) optionally, repeating the adsorption/desorption process one or more times; concentrating the solvent extracts from the adsorbent under reduced pressure or by distillation to obtain a first benzoic acid-enriched extract. Optionally, treating the first benzoic acid-enriched extract with water (approximately about 3 to about 5 grams of water per gram of first benzoic acid-enriched extract) one or more times and combining the treatment solutions, then steam distilling the treatment solutions to provide an aqueous solution. The aqueous solution can then be treated with a base, such as sodium hydroxide, to neutralize the aqueous solution and then can be concentrated under reduced pressure or distillation to provide a second benzoic acid-enriched extract.

Not to be limited by theory, it is considered that the adsorption-desorption of the benzoic acid/benzoic-acid enriched extract from an adsorbent is an advantage to obtain benzoic acid-enriched extracts in comparison to plant materials that have a naturally occurring percentage of benzoic acid present in the material.

In still another embodiment, the benzoic acid-enriched plant extract is prepared by a method comprising the steps of: 1) squeezing lingonberry to obtain a juice; 2) mixing the residue with water, wherein the weight ratio of lingonberry to water is in the range of from about 0.5 to about 5, particularly from about 1 to about 3, more particularly from about 1.5 to about 2, such as 0.5, 1.0, 1.5, 2.0, 2.5, etc., and mixing at room temperature for about 1 hour to about 10 hours to afford a mixture; 3) filtering the mixture and washing the resultant filter cake with water; 4) mixing the juice with the filtrate, and centrifuging the mixture at from about 3000 to about 5000 rpm for about 1 minute to about 20 minutes, and concentrating the supernatant at a temperature of from about 40° C. to about 70° C., particularly from about 50 to about 60° C., such as 40° C., 50° C., 60° C., 70° C., etc., under reduced pressure to obtain the concentrate; 5) heating the concentrate and refluxing for about 1 hour to about 5 hours; and 6) concentrating the material at a temperature of from about 50° C. to about 80° C., particularly from about 60 to about 70° C., such as 50° C., 60° C., 70° C., 80° C., etc., under reduced pressure to obtain the benzoic acid-enriched extract.

In still another embodiment, the plant material can be a fresh plant. In another embodiment, the plant material can be processed before being used, for example, the plant material can be frozen or can be stored in a warm condition for several days before being used.

The processes described herein generally do not involve the use of any chemical substance(s) to extract out the benzoic acid except for water, and thus the benzoic acid-enriched plant extract prepared do not contain any toxic substance(s) and/or appreciable organic solvent(s).

In another aspect, the use of the benzoic acid-enriched plant extracts as described herein, as a preservative, in the manufacture of food products, especially “green foods” are provided.

The benzoic acid-enriched compositions described herein can be incorporated into various foods, drinks, snacks, etc. In one aspect, the benzoic acid-enriched compositions can be added to a food product, prior to consumption. If added to a food product, a suitable carrier such as starch, sucrose or lactose, can be used to help distribute the concentration of the benzoic acid-enriched material making it easier to apply to the food product.

The benzoic acid-enriched compositions described herein can also be provided as supplements in various prepared food products. For the purposes of this application, prepared food product means any natural, processed, diet or non-diet food product to which a benzoic acid-enriched composition as described herein has been added. The benzoic acid-enriched compositions described herein can be directly incorporated into many prepared diet food products, including, but not limited to diet drinks, diet bars and prepared frozen meals. Furthermore, the benzoic acid-enriched compositions described herein can be incorporated into many prepared non-diet products, including, but not limited to candy, snack products such as chips, prepared meat products, milk, cheese, yogurt, sport bars, sport drinks, mayonnaise, salad dressing, bread and any other fat or oil containing foods. As used herein, the term “food product” refers to any substance fit for human or animal consumption.

The benzoic acid-enriched compositions described herein can be added to various drinks, such as fruit juices, milkshakes, milk, etc.

Furthermore, the benzoic acid-enriched compositions used as described herein may be mixed with other plant extracts like e.g., extracts from bitter melon, mulberry leaves, stevia, etc.

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

1. The following paragraphs enumerated consecutively from 1 through 81 provide for various aspects of the present invention. In one embodiment, in a first paragraph (1), a benzoic acid-enriched plant extract is provided, which has an increased benzoic acid content in comparison with the benzoic acid content that occurs naturally in the native plant.

2. The benzoic acid-enriched plant extract according to paragraph 1, which has an increased benzoic acid content of from 2 to about 100 times in comparison to the amount that is present in the native plant.

3. The benzoic acid-enriched plant extract according to paragraph 2, which has about 2, about 5, about 10, about 15, about 20, about 25, about 30, about 50, or about 100 times increased benzoic acid content, in comparison to the amount that is present in the native plant.

4. The benzoic acid-enriched plant extract according to paragraph 1, which has a benzoic acid content of 0.2 wt % to about 3 wt %.

5. The benzoic acid-enriched plant extract according to paragraph 4, which has a benzoic acid content of 0.4 wt. %.

6. The benzoic acid-enriched plant extract according to paragraph 5, which has a benzoic acid content of 0.5 wt. %.

7. The benzoic acid-enriched plant extract according to paragraph 4, which has a benzoic acid content of about 0.5 wt. %, about 0.6 wt. %, about 0.7 wt. %, about 0.8 wt. %, about 0.9 wt. %, about 1.0 wt. %, about 1.5 wt. %, about 2.0 wt. % or about 3 wt. %.

8. The benzoic acid-enriched plant extract according to any one of paragraphs 1-7, wherein the plant material is selected from berries.

9. The benzoic acid-enriched plant extract according to paragraph 8, wherein the plant is selected from lingonberry, cranberry, cloudberry and black crowberry.

10. The benzoic acid-enriched plant extract according to any one of paragraphs 1-9, wherein the plant is a fresh plant.

11. The benzoic acid-enriched plant extract according to any one of paragraphs 1-9, wherein the plant has been processed before being used.

12. The benzoic acid-enriched plant extract according to paragraph 11, wherein the plant has been stored in a warm environment for several days before being used. 13. The benzoic acid-enriched plant extract according to any one of paragraphs 1-12, wherein the plant extract is free of toxic substance(s) and organic solvent(s).

14. A process for preparing the benzoic acid-enriched plant extract according to any one of paragraphs 1-13, comprising the steps of:

1) mixing lingonberry with water, wherein the weight ratio of lingonberry to water is in the range of from about 0.5 to about 5;

2) heating the mixture for a sufficient period of time, and then cooling the mixture to room temperature;

3) filtering the mixture and washing the resultant filter cake with water; and

4) centrifuging the filtrate to obtain a supernatant, and concentrating the supernatant at an elevated temperature under reduced pressure to obtain the benzoic acid-enriched extract.

15. The process according to paragraph 14, wherein the weight ratio of lingonberry to water in step 1) is in the range of from about 1 to about 3.

16. The process according to paragraph 15, wherein the weight ratio of lingonberry to water in step 1) is in the range of fro about 1.5 to about 2.

17. The process according to paragraph 14, wherein the weight ratio of lingonberry to water in step 1) is 0.5, 1.0, 1.5, 2.0, or 2.5.

18. The process according to paragraph 14, wherein the concentration process in step 4) is carried out at a temperature of from about 60° C. to about 70° C.

19. The process according to paragraph 14, wherein the concentration process in step 4) is carried out at a temperature of 50° C., 60° C., 70° C., or 80° C.

20. A process for preparing the benzoic acid-enriched plant extract according to any one of paragraphs 1-13, comprising the steps of:

1) squeezing the lingonberry plant material to obtain juice and plant material residue;

2) mixing the plant material residue with water, wherein the weight ratio of lingonberry plant material to water is in the range of from about 0.5 to about 5, and mixing at room temperature to afford a mixture;

3) filtering the mixture and washing the resultant filter cake with water;

4) mixing the juice with the filtrate, and centrifuging the mixture to obtain a supernatant, and concentrating the supernatant at an elevated temperature under reduced pressure to obtain a concentrate;

5) optionally, heating the concentrate; and

6) optionally, concentrating the concentrate at an elevated temperature under reduced pressure to obtain the benzoic acid-enriched extract.

21. The process according to paragraph 14, wherein the weight ratio of lingonberry to water in step 2) is in the range of from about 1 to about 3.

22. The process according to paragraph 21, wherein the weight ratio of lingonberry to water in step 2) is in the range of from about 1.5 to about 2.

23. The process according to paragraph 21, wherein the weight ratio of lingonberry to water in step 2) is 0.5, 1.0, 1.5, 2.0, or 2.5.

24. The process according to paragraph 21, wherein the concentration process in step 4) is carried out at a temperature of from about 50° C. to about 60° C.

25. The process according to paragraph 21, wherein the concentration process in step 4) is carried out at a temperature of 40° C., 50° C., 60° C., or 70° C.

26. The process according to paragraph 21, wherein the concentration process in step 6) is carried out at a temperature of from about 60° C. to about 70° C.

27. The process according to paragraph 21, wherein the concentration process in step 6) is carried out at a temperature of 50° C., 60° C., 70° C., or 80° C.

28. Use of the benzoic acid-enriched plant extract according to any one of paragraphs 1-13 in the manufacture of food products.

29. The use according to paragraph 28, wherein the benzoic acid-enriched plant extract is used as a preservative.

30. A benzoic acid-enriched lingonberry plant composition derived from a lingonberry plant material, which has an increased benzoic acid content in comparison with the benzoic acid content that occurs naturally in the native lingonberry plant.

31. The benzoic acid-enriched lingonberry plant composition of paragraph 30, wherein the weight percent of benzoic acid content is greater than 0.2 wt. %.

32. The benzoic acid-enriched lingonberry plant composition of paragraph 30, wherein the weight percent of benzoic acid content is greater than 0.5 wt. %.

33. The benzoic acid-enriched lingonberry plant composition of paragraph 30, wherein the weight percent of benzoic acid content is from 0.2 wt. % to about 3.0 wt. %.

34. The benzoic acid-enriched lingonberry plant composition according to any one of paragraphs 30 through 33, wherein the plant material is selected from berries.

35. A benzoic acid-enriched cranberry plant composition derived from a cranberry plant material, which has an increased benzoic acid content in comparison with the benzoic acid content that occurs naturally in the native cranberry plant.

36. The benzoic acid-enriched cranberry plant composition of paragraph 35, wherein the weight percent of benzoic acid content is greater than 0.05 wt. %.

37. The benzoic acid-enriched cranberry plant composition of paragraph 35, wherein the weight percent of benzoic acid content is greater than 0.1 wt. %.

38. The benzoic acid-enriched cranberry plant composition of paragraph 35, wherein the weight percent of benzoic acid content is from 0.05 wt. % to about 3.0 wt. %.

39. The benzoic acid-enriched cranberry plant composition according to any one of paragraphs 35 through 38, wherein the plant material is selected from berries.

40. A benzoic acid-enriched cloudberry plant composition derived from a cloudberry plant material, which has an increased benzoic acid content in comparison with the benzoic acid content that occurs naturally in the native cloudberry plant.

41. The benzoic acid-enriched cloudberry plant composition of paragraph 40, wherein the weight percent of benzoic acid content is greater than 0.05 wt. %.

42. The benzoic acid-enriched cloudberry plant composition of paragraph 40, wherein the weight percent of benzoic acid content is greater than 0.3 wt. %.

43. The benzoic acid-enriched cloudberry plant composition of paragraph 40, wherein the weight percent of benzoic acid content is from 0.1 wt. % to about 3.0 wt. %.

44. The benzoic acid-enriched cloudberry plant composition according to any one of paragraphs 40 through 43, wherein the plant material is selected from berries.

45. A benzoic acid-enriched black crowberry plant composition derived from a black crowberry plant material, which has an increased benzoic acid content in comparison with the benzoic acid content that occurs naturally in the native black crowberry plant.

46. The benzoic acid-enriched black crowberry plant composition of paragraph 45, wherein the weight percent of benzoic acid content is greater than 0.05 wt. %.

47. The benzoic acid-enriched black crowberry plant composition of paragraph 45, wherein the weight percent of benzoic acid content is greater than 0.3 wt. %.

48. The benzoic acid-enriched black crowberry plant composition of paragraph 45, wherein the weight percent of benzoic acid content is from 0.1 wt. % to about 3.0 wt. %.

49. The benzoic acid-enriched black crowberry plant composition according to any one of paragraphs 45 through 48, wherein the plant material is selected from berries.

50. A method to preserve a food product comprising the step of adding a benzoic acid-enriched plant extract or composition of any of paragraphs 1 through 13 or 30 through 49 to a food product to form a mixture, wherein the benzoic acid content of mixture is from about 0.05 weight percent to about 0.1 weight percent.

51. The method of paragraph 50, provided that the food product is not one of lingonberry, cranberry, cloudberry or black crowberry.

52. The benzoic acid-enriched plant composition according to any one of paragraphs 30 through 49, wherein the plant extract is free of toxic substance(s) and organic solvent(s).

53. A benzoic acid-enriched plant extract, which has an increased benzoic acid content in comparison with the benzoic acid content that occurs naturally in the native plant, wherein the benzoic acid content is ≧20 wt. % by weight of the plant extract.

54. A benzoic acid-enriched plant extract, which has an increased benzoic acid content in comparison with the benzoic acid content that occurs naturally in the native plant, wherein the benzoic acid content is ≧90 wt. % by weight of the plant extract.

55. A benzoic acid-enriched plant extract, which has an increased benzoic acid content in comparison with the benzoic acid content that occurs naturally in the native plant, wherein the benzoic acid content about 100 wt. % by weight of the plant extract.

56. The benzoic acid-enriched plant extract according to any one of paragraphs 53-56, wherein the plant material is selected from berries.

57. The benzoic acid-enriched plant extract according to paragraph 56, wherein the plant is selected from lingonberry, cranberry, cloudberry and black crowberry.

58. The benzoic acid-enriched plant extract according to any one of paragraphs 53-57, wherein the plant is a fresh plant.

59. The benzoic acid-enriched plant extract according to any one of paragraphs 53-57, wherein the plant has been processed before being used.

60. The benzoic acid-enriched plant extract according to paragraph 59, wherein the plant has been stored in a warm environment for several days before being used.

61. The benzoic acid-enriched plant extract according to any one of paragraphs 53-60, wherein the plant extract is free of toxic substance(s) and organic solvent(s).

62. A benzoic acid-enriched lingonberry plant extract, which has an increased benzoic acid content in comparison with the benzoic acid content that occurs naturally in the lingonberry native plant, wherein the benzoic acid content is ≧20 wt. % by weight of the plant extract.

63. A benzoic acid-enriched lingonberry plant extract, which has an increased benzoic acid content in comparison with the benzoic acid content that occurs naturally in the lingonberry native plant, wherein the benzoic acid content is ≧90 wt. % by weight of the plant extract.

64. A benzoic acid-enriched lingonberry plant extract, which has an increased benzoic acid content in comparison with the benzoic acid content that occurs naturally in the lingonberry native plant, wherein the benzoic acid content is about 100 wt. % by weight of the plant extract.

65. The benzoic acid-enriched lingonberry plant extract according to any one of paragraphs 62-64, wherein the plant material is selected from berries.

66. The benzoic acid-enriched lingonberry plant extract according to any one of paragraphs 62-65, wherein the plant is a fresh plant.

67. The benzoic acid-enriched lingonberry plant extract according to any one of paragraphs 62-65, wherein the plant has been processed before being used.

68. The benzoic acid-enriched lingonberry plant extract according to paragraph 67, wherein the plant has been stored in a warm environment for several days before being used.

69. The benzoic acid-enriched lingonberry plant extract according to any one of paragraphs 62-68, wherein the plant extract is free of toxic substance(s) and organic solvent(s).

70. Use of the benzoic acid-enriched plant extract according to any one of paragraphs 53-69 in the manufacture of food products.

71. The use according to paragraph 70, wherein the benzoic acid-enriched plant extract is used as a preservative.

72. A method to preserve a food product comprising the step of adding a benzoic acid-enriched plant extract of any of paragraphs 53 through 69 to a food product to form a mixture, wherein the benzoic acid content of mixture is from about 0.05 weight percent to about 0.1 weight percent.

73. The method of paragraph 72, provided that the food product is not one of lingonberry, cranberry, cloudberry or black crowberry.

74. A process for preparing the benzoic acid-enriched plant extract according to any one of paragraphs 1-13, 30-49, or 53-73, comprising the steps of:

1) refluxing the juice of a benzoic acid containing fruit, optionally in the presence of additional water;

2) optionally cooling the mixture to room temperature;

3) centrifuging the mixture to provide a supernatant;

4) treating the supernatant with an adsorbent;

5) separating the adsorbent from the supernatant;

6) washing the adsorbent with a solvent to provide a filtrate; and

7) concentrating the filtrate to provide a benzoic acid containing enriched plant extract.

75. The process of paragraph 74, further comprising the steps:

8) distilling the filtrate of step 6) to afford a residue;

9) treating the residue with a base to provide a benzoic acid salt enriched plant extract material.

76. The process of paragraph 75, further comprising the step:

10) treating the residue of step 8 with one or more water steam distillations to afford one or more steam distillates;

11) combining the steam distillate(s); and

12) treating the distillates with a base to provide a benzoic acid salt enriched plant extract material.

77. The process of any of paragraphs 74 through 76, wherein the adsorbent is an activated carbon, silica gel, alumina, molecular sieves, white clay, diatomite, zeolites or mixtures thereof.

78. The process of any of paragraphs 74 through 77, wherein the solvent is non-toxic.

79. The process of paragraph 78, wherein the solvent is an ionic liquid or is a “green solvent”, such as a supercritical fluid, such as carbon dioxide.

80. The process according to any of paragraphs 14 through 27 and 74 through 79, wherein the benzoic acid-enriched extract comprises substantially 100% benzoic acid.

81. A benzoic acid-enriched plant extract comprising substantially 100% benzoic acid.

The invention will be further described with reference to the following non-limiting Examples. It will be apparent to those skilled in the art that many changes can be made in the embodiments described without departing from the scope of the present invention.

Thus the scope of the invention should not be limited to the embodiments described in this application, but only by embodiments described by the language of the claims and the equivalents of those embodiments. Unless otherwise indicated, all percentages throughout this specification are by weight.

### EXAMPLES

### Test Method

### 1. Reagents

Methanol: HPLC grade, B&J ACS, USA
Water: purified water, Wahaha, Hangzhou, Zhejiang, China
Benzoic acid: analytical grade, Wuhan Organic Synthsis Chemical Plant, China
KH₂PO₄: analytical grade, Tianjin Guangfu Technology Development Co. Ltd, China

### 2. Instrument and HPLC Condition

Instrument: Agilent 1100 LC system (Agilent Technologies, Palo Alto, Calif.)
Column: Agilent ZORBAX SB-C₁₈ (4.6×250 mm, 5 μm)
Wavelength: 230 nm
Temperature: room temperature
Flow rate: 1.0 ml/min
Injection volume: 10 μl
Detector: VWD
Mobile Phase: methanol: 0.05 mol/l KH₂PO₄ buffer solution (pH=3.5)=45:55
Retention time: 15 min.

### 3. Test Solutions

Preparation of the standard solution:
5 mg benzoic acid (as the standard) was put into a 50 ml volumetric flask, dissolved by the mobile phase, and filtrated by a 0.22 μm membrane.
Preparation of the test sample:
200 mg test sample was put into a 10 ml volumetric flask, dissolved by the purified water, and filtrated by a 0.22 μm membrane.

### 4. Calculation

$$Content \% = \frac{{A}_{test} \times {W}_{standard} \times {V}_{test}}{{A}_{standard} \times {W}_{test} \times {V}_{standard}} \times 100 \%$$

A_{test:} the peak area of the test sample
A_{standard}: the peak area of the standard
Wₜₑₛₜ: the weight of test sample (mg)
W_{standard}: the weight of the standard (mg)
Vₜₑₛₜ: the volume of the test sample (ml)
V_{standard}: the volume of the standard sample (ml)

### Example 1

1000 g of lingonberry fruit was mixed with 1500 ml water. The mixture was heated and refluxed for 4 hours and then cooled to room temperature. The mixture was filtered and the filter cake was washed with 100 ml water. The filtrate was centrifuged at 3800 rpm for 5 minutes and the supernatant was concentrated at 65° C. under reduced pressure to obtain 114 g extract in the form of a red sticky liquid with a benzoic acid content of 0.63%. Determined by HPLC. Percentage is a weight percentage.

### Example 2

Lingonberry juice was squeezed out of 1000 g lingonberry fruit. 500 g water was added to the residual and the mixture was stirred at room temperature for 5 hours. The mixture was filtered and the filter cake was washed with 100 g water. The filtrate and the juice was combined and then centrifuged at 3800 rpm for 5 minutes. The supernatant was concentrated at 50 under reduced pressure to obtain 300 g liquid. The liquid was heated and refluxed for 4 hours and then concentrated at 65° C. under reduced pressure to obtain 90 g extract in the form of a red sticky liquid with a benzoic acid content of 0.87%. Determined by HPLC. Percentage is a weight percentage.

### Example 3

200 g of lingonberry fruit was mixed with 300 ml water. The mixture was heated to 70° C. for 4 hours and then cooled to room temperature. The mixture was filtered and the filter cake was washed with 100 ml water. The filtrate was centrifuged at 5000 rpm for 5 minutes and the supernatant was concentrated at 60° C. under reduced pressure to obtain 34.9 g extract in the form of a red sticky liquid with a benzoic acid content of 0.43 wt. %, as determined by HPLC. Determined by HPLC. Percentage is a weight percentage.

### Example 4

Lingonberry juice was squeezed from of 3000 g lingonberry fruit approximately 2400 ml of liquid was obtained. Approximately 2300 ml of water was added to the residual solids and the mixture was stirred at room temperature for 3 hours. The additional of the water is optional. The mixture was filtered and the filtrate was combined with the previously isolated juice, and a total of 4770 ml liquid was obtained. The liquid was heated at refluxed for 4 hours, cooled, and then centrifuged at 3800 rpm. A solid was removed and 4660 ml supernatant was obtained. 35 g activated carbon was added into the supernatant and the system was stirred for about 4 hours at room temperature and then the activated carbon was filtered off. The activated carbon was mixed with 350 ml ethanol with stirring and was filtered. The activated carbon was washed repeatedly with ethanol as a desorption process 4 times, and the ethanol filtrates (about 1300 ml) were combined. 650 ml of the ethanol filtrate was concentrated by rotatory evaporation, to provide 5.6 g of a product as red sticky liquid with a benzoic acid content of 21.8 wt. %. The content was determined by HPLC as described in the test method.

The remaining 650 ml of the ethanol filtrate was distilled until a sticky residue was obtained, the first distilled aqueous liquid was collected, a 1000 ml portion of water was added to the sticky residue and distilled. The distillation treatment of the sticky residue was repeated several times and the additional collected distilled aqueous liquids were combined to obtain about 5000 ml of distilled liquid. The distilled liquid was neutralized with sodium hydroxide, and then was concentrated by rotating evaporation, in order to obtain 1.4 g product as a white powder lingonberry extract with benzoic acid content of 93.68 wt, calculated as sodium benzoate by HPLC as described above.

### Example 5

### Bacteria Inhibiting Effect of Benzoic Acid Enriched Extract

1. Reagents (preservatives):
Lingonberry extract (benzoic acid content=0.53%)
Benzoic acid (analytical grade)
Sorbic acid (analytical grade)
2. Preparation of bacterial suspension
Activated Aspergillus niger was diluted to 50 cfu/ml with sterilized sodium chloride, in order to provide a bacterial suspension.
3. Dilution-plate method

The preservatives were dissolved with sterilized water and diluted to the concentrations in Table 1. 1 ml of each sample was added into a sterilized Petri dish, and then 1 ml bacterial suspension was added into each dish. The sample and the bacterial suspension were well mixed in the dish and 20 ml sterilized culture medium was added into the dish at ≦45° C., such that the final concentration of the preservatives is as described in Table 1. After solidification, the dish was incubated in a constant temperature incubator at 27° C. for 72 h, and the number of the colony was then counted.

TABLE 1

| | Initial concentration | Final concentration of |
|---|---|---|
| preservative | of the preservative % | the preservative % |
| Benzoic acid | 0.8 | 0.04 |
| (control) | 0.4 | 0.02 |
| | 0.2 | 0.01 |
| Sorbic acid | 0.4 | 0.02 |
| (control) | 0.2 | 0.01 |
| Lingonberry extract | 1.0 | 0.05 |
| (calculated as | 0.8 | 0.04 |
| benzoic acid) | 0.6 | 0.03 |
| | 0.4 | 0.02 |
| | 0.2 | 0.01 |

4. Results
The results are provided in Table 2

| | Final concentration of | colony number | Inhibition |
|---|---|---|---|
| sample | the preservative % | cfu/dish | % |
| Culture medium | 0 | 0 | — |
| (blank) | | | |
| bacterial suspension | 0 | 53 | — |
| (blank) | | | |
| Benzoic acid | 0.04 | 20 | 62 |
| (control) | 0.02 | 32 | 40 |
| | 0.01 | 49 | 0 |
| Sorbic acid | 0.02 | 33 | 38 |
| (control) | 0.01 | 50 | 0 |
| Lingonberry extract | 0.05 | 0 | 100 |
| (calculated as | 0.04 | 0 | 100 |
| benzoic acid) | 0.03 | 16 | 70 |
| | 0.02 | 36 | 32 |
| | 0.01 | 50 | 0 |

It can be seen from the results that the lingonberry extract as described herein has a comparable or even higher bacterial inhibition effect as compared to benzoic acid and sorbic acid at the same concentration (calculated as benzoic acid). Not to be limited by theory, it suggests that there might be some synergistic effect in the lingonberry extract with the reduction of bacterial growth.

It also can be seen from the results that the lingonberry extract exhibits its inhibition effect on Aspergillus niger at concentration of ≧0.02% (calculated as benzoic acid).

What is claimed is:

1. A benzoic acid-enriched plant extract, which has an increased benzoic acid content in comparison with the benzoic acid content that occurs naturally in the native plant.

2. A benzoic acid-enriched plant extract comprising substantially 100% benzoic acid.

3. A benzoic acid-enriched plant extract, which has an increased benzoic acid content in comparison with the benzoic acid content that occurs naturally in the native plant, wherein the benzoic acid content is from about 0.5 to about 2 wt. % by weight of the plant extract.

4. The benzoic acid-enriched plant extract according to claim 3, wherein the plant material is selected from berries.

5. The benzoic acid-enriched plant extract according to claim 4, wherein the plant is selected from lingonberry, cranberry, cloudberry and black crowberry.

6. The benzoic acid-enriched plant extract according to claim 3, wherein the plant extract is free of toxic substance(s) and organic solvent(s).

7. A process for preparing a benzoic acid-enriched plant extract according, comprising the steps of:
1) refluxing juice of a benzoic acid containing fruit, optionally in the presence of additional water;
2) optionally cooling the mixture to room temperature;
3) centrifuging the mixture to provide a supernatant;
4) treating the supernatant with an adsorbent;
5) separating the adsorbent from the supernatant;
6) washing the adsorbent with a solvent to provide a filtrate; and
7) concentrating the filtrate to provide a benzoic acid containing enriched plant extract.

8. The process of claim 7, further comprising the steps:
8) distilling the filtrate of step 6) to afford a residue;
9) treating the residue with a base to provide a benzoic acid salt enriched plant extract material.

9. The process of claim 8, further comprising the steps:
10) treating the residue of step 8 with one or more steam distillations to afford one or more steam distillates;
11) combining the steam distillate(s); and
12) treating the distillates with a base to provide a benzoic acid salt enriched plant extract material.

10. The process of claim 7, wherein the adsorbent is an activated carbon, silica gel, alumina, molecular sieves, white clay, diatomite, zeolites or mixtures thereof.

11. The process of claim 7, wherein the solvent is non-toxic.

12. The process of claim 11, wherein the solvent is an ionic liquid or a supercritical fluid.

13. The process of claim 7, wherein the benzoic acid-enriched extract comprises substantially 20% benzoic acid.

14. The process of claim 7, wherein the benzoic acid-enriched extract comprises about 0.5 to about 2 wt. % benzoic acid.

15. A method to preserve a food product comprising the step of adding a benzoic acid-enriched plant extract or composition of claim 1 to a food product to form a mixture, wherein the benzoic acid content of mixture is from about 0.05 weight percent to about 0.1 weight percent.

16. The method of claim 15, provided that the food product is not one of lingonberry, cranberry, cloudberry or black crowberry.

17. A method to preserve a food product, a pharmaceutical agent or personal care product, comprising the step of adding plant juice obtained from an immature plant material having benzoic acid, selected from the plants of Vaccinium, Rubus, or Empetrum nigrum.

18. A method to increase the acidulant effect in a food product, in a pharmaceutical agent or in personal care products, comprising the step of adding a suitable amount of plant juice obtained from an immature plant material having benzoic acid, selected from the plants of Vaccinium, Rubus, or Empetrum nigrum to increase the acidulant taste of the product.

19. Use of the benzoic acid-enriched plant extract according to claim 1 in the food industry.

20. The use according to claim 19, wherein the benzoic acid-enriched plant extract is used as an acidulant, a taste enhancer, or a preservative.

21. Use of the benzoic acid-enriched plant extract according to claim 1 in feeds, nutraceuticals, pharmaceuticals, or cosmetics.

22. The use according to claim 21, wherein the benzoic acid-enriched plant extract is used for antifatigue ingredient, exfoliation of the skin, and/or personal care.
